(19) United States
(12) Patent Application Publication
(10) Pub. No.: US 2026/0154681 A1
(43) Pub. Date: Jun. 4, 2026

(54) AGENTIC MICROTRANSACTIONS THROUGH VERIFIABLE PAYMENT DELEGATION

(71) Applicant: Mastercard International Incorporated, Purchase, NY (US)

(72) Inventor: Soumyajit Mitra, London (GB)

(21) Appl. No.: 19/461,197

(22) Filed: Jan. 27, 2026

(51) Int. Cl. G06Q 20/40; G06Q 20/22

(52) U.S. Cl. CPC G06Q 20/40; G06Q 20/29; G06Q 2220/00

(57) ABSTRACT

A method for agentic microtransactions through verifiable payment delegation includes, during a single Internet Protocol session between a client and a server in which content hosted by the server is being or is to be accessed by the client, receiving, at a facilitator, a transaction request message including a transaction identifier, a transaction amount, a personal account number (PAN), and a cryptographic signature transmitted to the server from the client as part of the session; generating, at the facilitator, an authorization request message including at least the PAN and the cryptographic signature; sending, by the facilitator, the authorization request message to a payment network; receiving, at the facilitator from the payment network, an authorization response indicating approval of the transaction based on the public key corresponding to the cryptographic signature being a delegate of the PAN; and sending, from the facilitator to the server, payment authorization confirmation during the session.

### BACKGROUND

A payment network involves a collection of systems that facilitate the communication and transfer of funds. Typically, a cardholder makes a purchase through a point of interaction (POI) device/point-of-sale (POS) terminal associated with a merchant. The POI/POS connects to the payment network, via an acquirer, to route and communicate transaction messages across the payment network to an issuer. Return messages, such as pre-authorization response messages and authorization response messages, from the issuer are routed and communicated back across the payment network to the merchant.

### BRIEF SUMMARY

Systems and techniques for agentic microtransactions through verifiable payment delegation during a single Internet Protocol (IP) session are described.

In some aspects, the techniques and systems described herein relate to a method including: during a session between a client and a server over an Internet protocol in which content hosted by the server is being or is to be accessed by the client, receiving, at a facilitator, a transaction request message including a transaction identifier, a transaction amount, a personal account number (PAN), and a cryptographic signature transmitted to the server from the client as part of the session; generating, at the facilitator, an authorization request message including at least the PAN and the cryptographic signature; sending, by the facilitator, the authorization request message to a payment network; receiving, at the facilitator from the payment network, an authorization response indicating approval of the transaction based on a public key corresponding to the cryptographic signature being a delegate of the PAN; and sending, from the facilitator to the server, payment authorization confirmation during the session.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A illustrates an example session between a client and a server.

FIG. 1B illustrates an example graphical user interface displayed at the client during a session.

FIG. 1C illustrates an example checkout session between the client and the server.

FIG. 1D illustrates an example graphical user interface displayed at the client during a checkout session.

FIG. 1E illustrates an example transaction flow for a payment network.

FIG. 1F illustrates an example confirmation graphical user interface displayed at the client.

FIG. 2 illustrates an example process for an agentic microtransaction during a single IP session.

FIG. 3 illustrates an example method for enabling agentic microtransactions during a single IP session.

FIG. 4 illustrates an example operating environment of a mapping service.

FIG. 5 illustrates components of a computing system.

### DETAILED DESCRIPTION

Systems and techniques for agentic microtransactions during a single Internet Protocol (IP) session are described.

An “IP session”, or “session”, is a time-delimited two-way link and considered a practical (relatively high) layer in the Transmission Control Protocol (TCP)/Internet Protocol (IP) enabling interactive expression and information exchange between two or more communication devices or endpoints (e.g., computers, automated systems, or live active users). A session is established at a certain point in time and then ended (e.g., “torn down”) at some later point. An established communication session can involve more than one message in each direction. A session can be implemented as part of protocols and services at the application layer.

For example, Hypertext Transfer Protocol (HTTP) is an application layer protocol in the Internet protocol suite for distributed, collaborative, hypermedia information systems. HTTP is a request-response protocol in the client-server model. The client-server model is a form of messaging pattern in a distributed application structure that partitions tasks or workloads between the providers of a resource or service (e.g., servers) and service requesters (e.g., clients). In some cases, additional security between communications is possible by utilizing an added encryption layer of secure sockets layer (SSL)/transport layer security (TLS), following the Hypertext Transfer Protocol Secure (HTTPS) protocol.

In a common scenario, a web browser acts as the client, and a web server, hosting one or more websites, is the server. A web browser can be an example of a user agent. In some cases, a user agent can be an artificial intelligence (AI) agent or an autonomous agent. In some cases, an AI agent or an autonomous agent can perform an action without user involvement. Additional examples of user agents can include, but are not limited to, web crawlers, voice browsers, mobile applications, and other software that accesses, consumes, or displays web content.

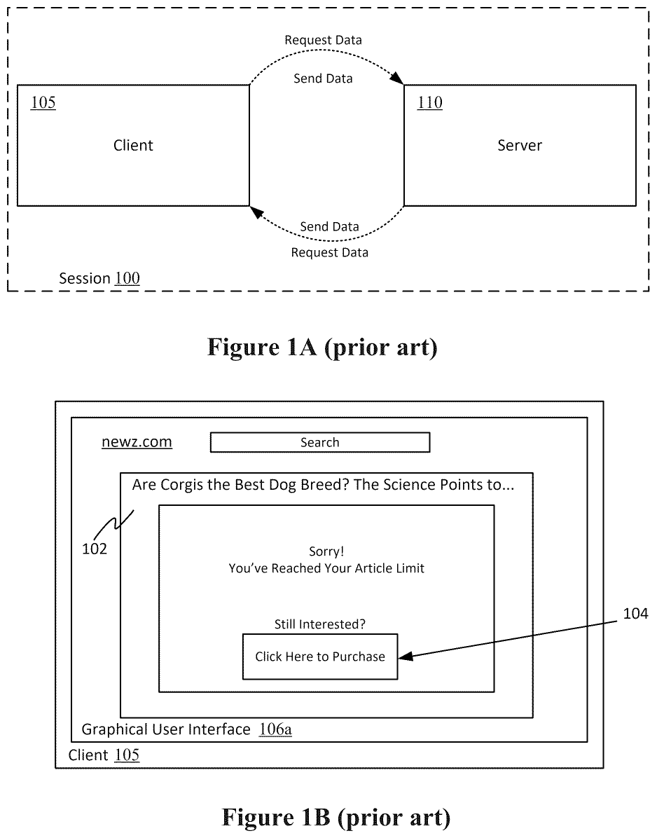

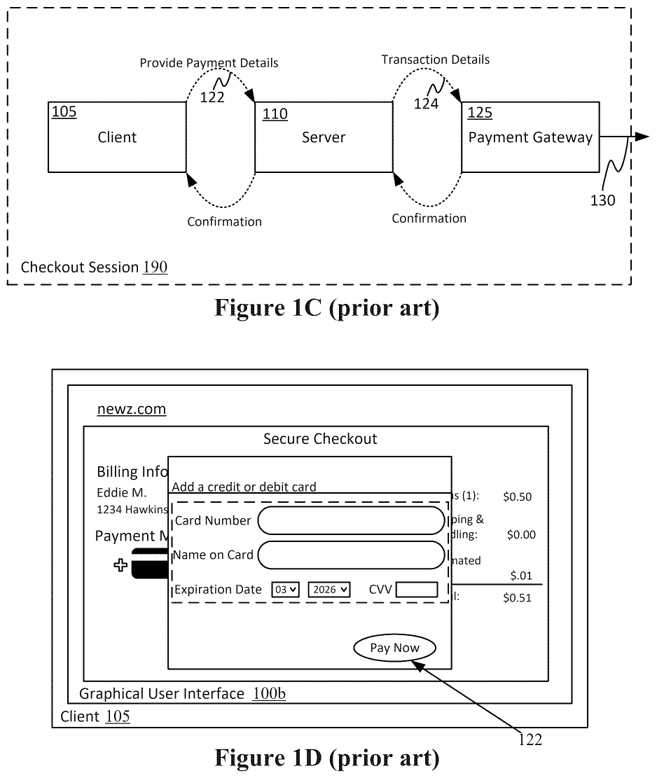

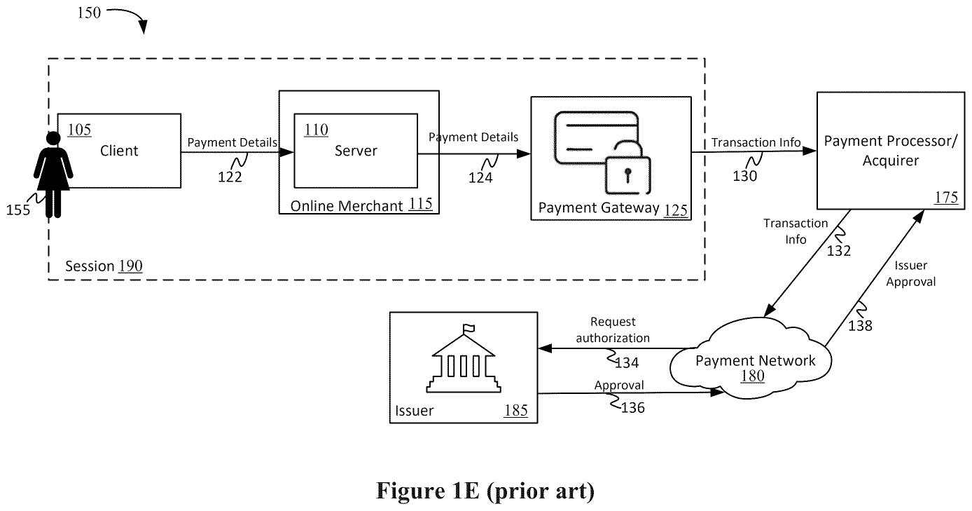

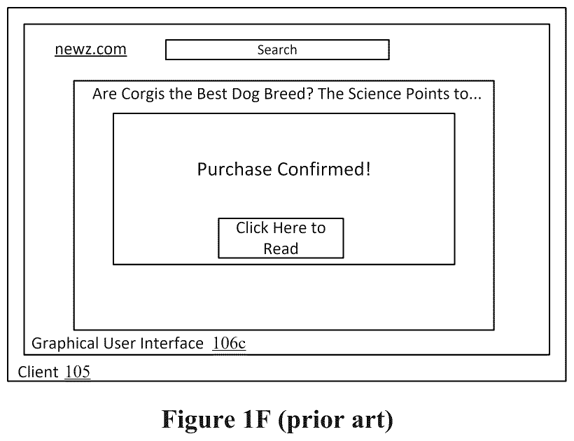

FIGS. 1A-1F illustrate a conventional scenario in which a payment transaction is initiated using a separate session from a session in which content is to be or is being accessed. FIG. 1A illustrates an example session between a client and a server; FIG. 1B illustrates an example graphical user interface displayed at the client during a session; FIG. 1C illustrates an example checkout session between the client and the server; FIG. 1D illustrates an example graphical user interface displayed at the client during a checkout session; FIG. 1E illustrates an example transaction flow for a payment network; and FIG. 1F illustrates an example confirmation graphical user interface displayed at the client.

Referring to FIG. 1A, a session 100 can be established between the client 105 and the server 110. The client 105 is a device or software application that requests resources from another device or software application (e.g., the server 110) that provides/hosts the resources. Client 105 can be “thick” or “thin” corresponding to amount of application logic running on the client device itself. In some cases, the client 105 can be a machine, a computing device, a browser, a web server, or other system capable of participating in a session as a service requester. In some cases, the server 110 can be a machine, a computing device, a web server, or other system capable of participating in a session as the provider of a resource or service. The server 110 can host content and run associated programs and/or applications. In some cases, the server 110 can include one or more computing devices. In some cases, session 100 is an HTTP/HTTPS session.

During the session 100, content (or other data) can be requested and received. For a scenario in which the server 110 is a provider of content, the client 105 can request access to and receive the content provided by the server 110.

Referring to FIG. 1B, the content displayed in graphical user interface (GUI) 106a can be provided by the server 110 for display at the client 105 during the session 100. A website “newz.com” can be hosted by server 110. In some cases, “newz.com” can be at a server 110 hosted on behalf of an entity (e.g., online merchant 115 described with respect to FIG. 1E), for example, the server 110 can be hosted by cloud services or server space providers, or be dedicated hardware for the entity.

For example, as shown at GUI 106a, a user may be browsing “newz.com” (provided by the server 110) via the client 105. As the user is browsing the “newz.com” webpage via their client 105, the client 105 and the server 110 are exchanging information during the session 100 using an Internet protocol (e.g., HTTP).

As shown in GUI 106a, the article 102 on “newz.com” is behind a paywall and requires payment by the user for further access.

In a conventional manner, when the user, via the client 105, selects the purchase option 104 (e.g., “Click Here to Purchase”), a separate, new session 190, is established for the transaction, as shown in FIG. 1C.

Referring to FIGS. 1C-1D, in prior art systems, in response to the request to purchase the article (e.g., selecting the purchase option 104 as illustrated in FIG. 1B), a checkout session 190 is initiated. The checkout session 190 is a different, separate session from session 100. The checkout session 190 can be a session that enables authentication of online transactions with EMV 3D Secure (3DS) protocol. The checkout session can utilize the Standalone (Sessions) API or other payment API.

The checkout session 190 can be established between at least the client 105 and the server 110. In some cases, the checkout session 190 can involve a payment gateway 125. The payment gateway can enable the server 110 to accept debit and/or credit card purchases. In some cases, the server 110 can host the checkout session 190. In some cases, the payment gateway 125 (on behalf of the server 110) can host the checkout session 190. A server 110 incorporating and/or utilizing a payment gateway 125 can be considered an online merchant 115.

For example, with reference to FIGS. 1C-1E, a conventional transaction flow 150 performed over the checkout session 190 can begin at step (122), where the user 155, via client 105, can provide payment details (e.g., via graphical user interface 100b shown in FIG. 1D) to the server 110 and/or payment gateway 125 during the checkout session 190. The payment details can include, but are not limited to, a personal account number (PAN) (or “card number”), CVV, expiration date, cardholder name, and cardholder address.

As shown at step (124) the payment gateway 125 receives the payment details from the client 105 (e.g., via the server 110), for example, when user 155 enters payment card details as shown in GUI view 100b of FIG. 1B. In some cases, at step (124), the server 110 provides additional transaction information to the payment gateway 125, for example, a merchant identifier and transaction total.

Then, the payment gateway 125 securely transmits transaction information to a payment processor/acquirer 175, as shown at step (130). The transaction information can include, but is not limited to, the payment card details, the merchant identifier, and the transaction total. A payment processor is a company or service that facilitates electronic transactions—such as payments made with credit cards, debit cards, or digital wallets—between businesses and their customers.

Then, at step (132), the payment processor/acquirer 175 can send the transaction information (including the payment details) to a payment network 180 (e.g., card network) for verification of the user's 155 payment information.

Upon verification, the payment network 180 can request authorization for the release of funds from the issuer 185, as shown at step (134). If the issuer 185 confirms that the user has sufficient funds to pay for the online transaction, the issuer 185 can send a response to the payment network 180 to approve the transaction, as shown at step (136). In some cases, if the issuer 185 confirms that the user does not have sufficient funds, or for another reason, such as risk of fraud, the issuer 185 can send a response to the payment network 180 to deny the transaction.

Once the authorization response is received, the payment network 180 can forward the authorization response to the payment processor/acquirer 175, as shown at step (138). The payment processor/acquirer 175 can forward the authorization response to the online merchant 115 (e.g., at the server 110) to confirm the transaction has been accepted.

After the server 110 receives confirmation that the transaction has been authorized, the server 110 can display a signal of success and allow the user access to the request content, for example, as shown by GUI 106c illustrated in FIG. 1F.

Later on, settlement and clearing can occur. In clearing, the payment information can be double checked for accuracy. In settlement, the issuer 185 can transfer funds to the payment network 180; the payment network 180 can then transfer the funds to the payment processor/acquirer 175. Once the payment processor/acquirer 175 receives the funds, the funds can be made available to the online merchant 115.

With the adoption of artificial intelligence (AI) tools and agents, along with other applications, the payment transaction infrastructure can be improved and enhanced to support microtransactions and agent interactions while maintaining security and privacy required for payment transactions. For example, establishing secondary sessions for payment transactions on behalf of the agents can consume considerable computing resources. Additionally, currently, there are not means for agents operating without user involvement to authenticate themselves during a transaction.

As noted above, systems and methods are described herein that enable agentic microtransactions during a single IP session (e.g., just session 100) instead of the separate sessions illustrated in FIGS. 1A and 1C.

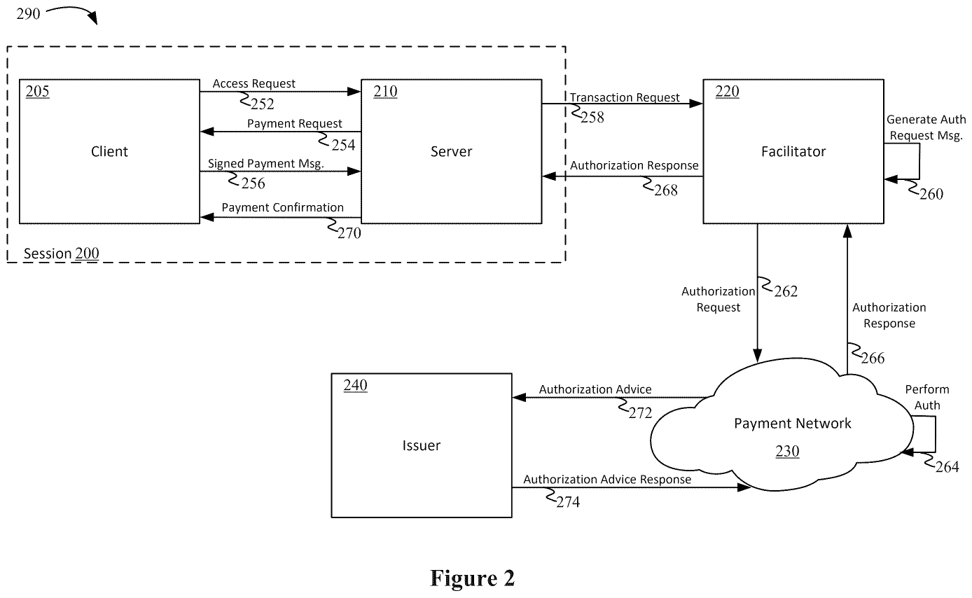

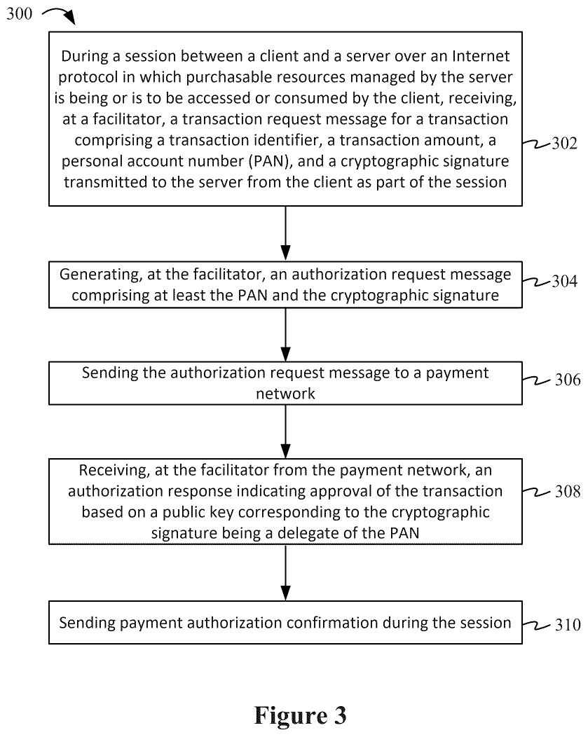

FIG. 2 illustrates an example inventive process for an agentic microtransaction during a single IP session. FIG. 3 illustrates an example inventive method for enabling agentic microtransactions during a single IP session.

A microtransaction can be a transaction having a relatively small payment amount (i.e., micropayment), including fractions of a dollar or even fractions of a cent. A fractional fiat currency transaction is a micropayment of a fraction of a single unit of fiat currency (e.g., 0.35 USD is a fraction of $1 USD). In some cases, a microtransaction can be sums that are relatively low in relation to a present value of a particular fiat currency (e.g., $1USD, $5USD, 150 yen, 1.38 Euro, etc.). In some cases, a microtransaction is a transaction having a value that is extremely small, such that it is unprofitable to process (e.g., via merchants, payment partners, etc.).

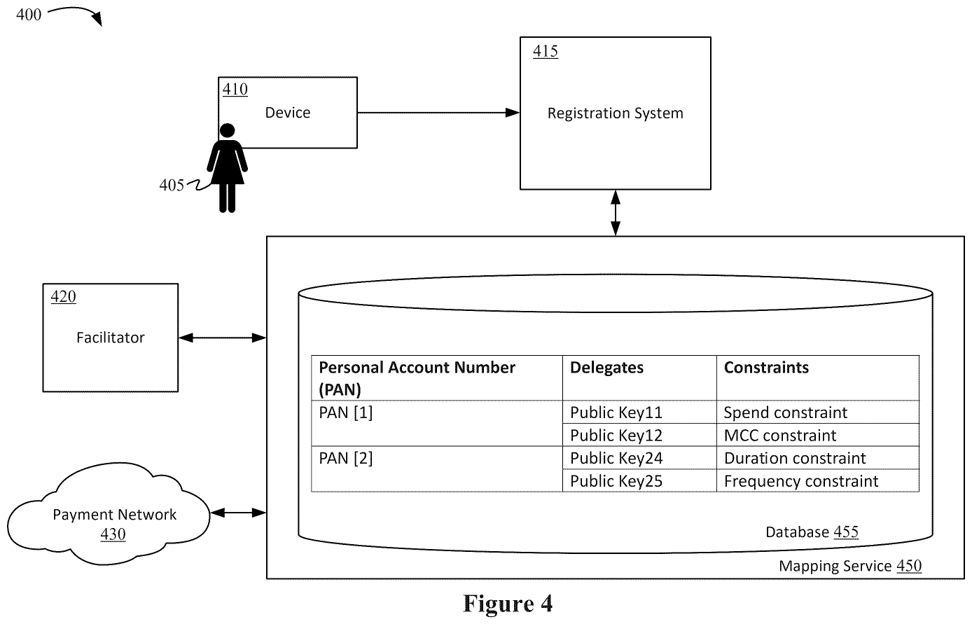

As an illustrative scenario for an agentic microtransaction, a user may have set up a bot client to read and summarize articles on dog breeds and granted authorization for the bot to make purchases up to a certain amount. As described in more detail with respect to FIG. 4, the bot authorization for making the purchases is recorded in association with the payment network with a delegate identifier and information regarding relevant constraints.

Referring to FIG. 2, client 205 and server 210 can be implemented as described with respect to client 105 and server 110. Following the illustrative scenario, client 205 can be the bot client that is attempting to access content provided by server 210.

Process 290 for an agentic microtransaction involves a single session 200 that is established between a client 205 and a server 210 during which both an access operation (or other exchange of information) and a micro-transaction (on a payment network 230 via a facilitator 220) can be carried out. By leveraging IP standards such as X402 (an Internet Protocol standard for one web service to speak with another web service in a payment context), and derivative standards for payments, it is possible to initiate the transaction without a separate session directed specifically with a payment network. Advantageously, unlike the process described with respect to FIGS. 1A-1F, the process 290 can occur without initiating a second session (e.g., checkout session 190 described with respect to FIG. 1E). In addition, a facilitator 220 can be used to support the micro-transaction while the client 205 and server 210 are communicating during the single session 200.

At step (252), a session 200 is established and during the session 200, the client 205 sends an access request message to the server 210. The access request message may be, for example, to access content such as the paywalled article 102 described with respect to FIG. 1B. The client 205 can send the access request message autonomously (e.g., when client is acting as an autonomous agent/bot). However, it should be understood that the described process for agentic microtransactions can also be carried out when a user is directly controlling/triggering client operations (e.g., such as in the case illustrated in FIG. 1B).

At step (254), in response to receiving the access request message, the server 210 sends a payment request message to the client 205. In some cases, the payment request message is in X402 standard.

At step (256), in response to receiving the payment request message, the client 205 can send a signed payment message to the server 210. The signed payment message can include information such as a transaction identifier, an account counter, a transaction amount, a personal account number (PAN), and a cryptographic signature (e.g., a signature over a cryptographic hash of the signed payment message) The cryptographic signature is a signature over a cryptographic hash of the signed payment message that can be signed using a private key stored by the client 205 that corresponds to a pre-registered public key. More or fewer elements of information may be included. In some cases, the transaction identifier can be a nonce. In some cases, the PAN is a Funding PAN (FPAN). In some cases, the PAN is a Device PAN (DPAN).

As discussed in more detail with respect to FIG. 4, a public key can be pre-registered for each delegate of a particular PAN (i.e., the public key is associated with the PAN). The public key can correspond to a private key that is used to sign the transaction message This delegation can be registered by a mapping service (e.g., mapping service 450 as described with respect to FIG. 4) and stored by a storage resource (e.g., database 455 described with respect to FIG. 4) at facilitator 220 and/or the payment network 230. The delegated public key can be used by delegates of the owner of the PAN (e.g., user/cardholder). For example, in some cases, the delegate public key could be provided to a bot client (e.g., client 205) operating on behalf of the owner of the PAN. Multiple bot clients may each be a delegate and have a corresponding delegate public key.

Upon receiving the signed payment message, at step (258), the server 210 can send a transaction request message to facilitator 220. The transaction request message includes at least the PAN and the cryptographic signature (e.g., a signature over the cryptographic hash of the payment message), and the signed payment message). In some cases, the transaction request message further includes, but is not limited to, the transaction identifier, a merchant identifier, an account counter, and a transaction total.

Facilitator 220 can be embodied by one or more computing systems and include instructions that when executed by one or more processors of one or more of the one or more computing systems cause method 300 to be performed.

A facilitator refers to a computing system that is on or in communication with a payment network 230.

Referring to both FIG. 2 and FIG. 3, method 300 can be performed by the facilitator 220 during a session (e.g., session 200) between a client 205 and a server 210 over an Internet protocol in which purchasable resources managed by the server is being or is to be accessed or consumed by the client. During this session, as shown in FIG. 2, the server 210 can send a payment request message (e.g., in X402 standard) to the client 205 to initiate a transaction).

The method 300 can begin by receiving (302) a transaction request message (e.g., transaction request step 258 of FIG. 2). The transaction request message can include a transaction identifier, a transaction amount, a personal account number (PAN), and a cryptographic signature. In some cases, the transaction request message further includes a merchant identifier (e.g., for a merchant associated with the server 210). In some cases, the transaction request message can be generated by the server 210 during the session 200 between the client 205 and the server 210.

Method 300 further includes generating (304) an authorization request message comprising at least the PAN and the cryptographic signature. For example, in FIG. 2, the step (260) can include generating an authorization request message.

To obtain authorization for the transaction, at step (260), upon receiving the transaction request message from the server 210, the facilitator 220 can generate an authorization request message. In some cases, an authorization request message includes at least the PAN the cryptographic signature (e.g., signature over the cryptographic hash of the transaction message). In some cases, the authorization request message further includes, but is not limited to, a signed payment message (e.g., received by the server 210 from the client 205), the transaction identifier, a merchant identifier associated with the server 210, and a transaction total.

In some cases, the authorization request message can include an indication that a public key corresponding to the cryptographic signature is registered as a delegate of the PAN. For example, as discussed in more detail with respect to FIG. 4, in some cases, generating (304) the authorization request message can include determining whether a public key corresponding to the cryptographic signature is a delegate of the PAN. In some cases, determining whether a public key corresponding to the cryptographic signature is a delegate of the PAN can occur before generating (304) the authorization request message.

In some cases, if it is determined that a public key corresponding to the cryptographic signature is a delegate of the PAN, the authorization request message can include an affirmative indication that the public key corresponding to the cryptographic signature is a delegate of the PAN. In some cases, if it is determined that a public key corresponding to the cryptographic signature is not a delegate of the PAN, the authorization request message can include a negative indication that the public key corresponding to the cryptographic signature is not a delegate of the PAN.

Upon generating (304) the authorization request message, the method 300 continues by sending (306) the authorization request message to a payment network. For example, as shown in FIG. 2, the facilitator 220 sends an authorization request message to payment network 230 at step (262).

In some cases, the authorization request message is an ISO 8583 message structure (e.g., a 0110 message). As illustrated, the authorization request message is sent over the payment card network (e.g., payment card rail).

As shown in FIG. 2, at step (264), upon receiving the authorization request message, the payment network 230 can perform authorization for the transaction. The authorization can be based in part on determining whether a public key corresponding to the cryptographic signature is a delegate of the PAN. For example, if the payment network determines that a public key corresponding to the cryptographic signature is a delegate of the PAN, the payment network 230 can generate an authorization response indicating approval of the transaction based on the public key corresponding to the cryptographic signature being a delegate of the PAN. In some cases, if the payment network determines that a public key corresponding to the cryptographic signature is not a delegate of the PAN, the payment network 230 can generate an authorization response indicating denial of the transaction based on a public key corresponding to the cryptographic signature not being a delegate of the PAN. An example method for determining whether a public key corresponding to the cryptographic signature is a delegate of the PAN by the payment network 230 is described in more detail with respect to FIG. 4.

Method 300 further includes receiving (308) an authorization response indicating approval of the transaction based on a public key corresponding to the cryptographic signature being a delegate of the PAN. This authorization response can be received by the facilitator 220 from the payment network 230, as shown at step (266) of FIG. 2. In some cases, method 300 can include receiving an authorization response indicating denial of the transaction based on the public key not being a delegate of the PAN. The authorization response can be sent over the payment card network. In some cases, the authorization response is an ISO 8583 message structure.

In response to receiving (308) the authorization response, the method 300 includes sending (310) payment authorization confirmation during the session. The sending (310) of the payment authorization confirmation can be sent from the facilitator to the server during the same session in which the transaction request message was sent/received.

For example, as shown in FIG. 2, at step (268) the facilitator 220 can send an authorization response message to the server 210 during session 200. Similar to the scenario where payment authorization is a success, method 300 can include sending payment denial during the session (e.g., where the public key corresponding to the cryptographic signature is not a delegate of the PAN).

As a result of the server 210 receiving the authorization response, the server 210 can provide payment confirmation message, as shown at step 270. In some cases, as a result of the transaction authorization, the client 205 may now have access to the particular content.

Advantageously, the entirety of the agentic microtransaction by the delegate described with respect to FIGS. 2-3 occurs during a single session between client 205 and server 210, without a second session (e.g., a separate authentication session) being initiated during the process 290 (for example, session 190 described with respect to FIGS. 1C-1F would not be initiated).

At some point in time, the payment network 230 can send (272) an authorization advice message to the issuer. The authorization advice message can be a non-financial advice message (NFA message). A NFA message refers to a message routed through the payment network that is not associated with performing a transaction. Advice messages can be used to provide confirmation or acknowledgement of certain states, for example, providing additional information between parties. In response, the issuer 240 can send (274) authorization advice response. Advantageously, the issuer 240 does not need to actively participate in process 290 for the agentic microtransaction to occur (e.g., as is the case in transaction flow 150 as described with respect to FIG. 1E).

There are instances where a facilitator (e.g., facilitator 220) may generate and send a message for payment execution over a blockchain network utilizing transferable balance recorded on blockchain such as stablecoins. For example, payments over a blockchain network are executed by individual computers or nodes constituting the blockchain network in response to a proposal of a block that includes the transaction (e.g., proposal by a facilitator, such as facilitator 220 or any computer or node willing to propose a block that includes the transaction submitted by the facilitator). The block can include a cryptographic signature. When the blockchain network receives the block that includes the transaction, the block is sent to every node in the network, and each node validates the transactions.

Conventionally, blockchain does not require the same authentication process as is utilized in an online checkout session involving a credit/debit card and a payment network - since execution can occur on the blockchain with just the information in the block message (e.g., cryptographic signature for which a public key could be recovered). However, there exists challenges with utilizing blockchain, such as the need to procure stablecoin balance ahead of a microtransaction, as well as the general lack of credit-based payment mechanisms.

Whereas many people do not have pre-established stablecoins available for micropayments, the majority of users do have a credit/debit card and/or bank account that is used for payment. Advantageously, the process 290 utilizes existing payment network infrastructure to enable quick authorization and efficient agentic micropayments using IP standards such as X402, all of which can occur during the single session 200.

FIG. 4 illustrates an example operating environment of a mapping service. Referring to FIG. 4, the operating environment 400 can include a cardholder 405, a device 410, a registration system 415, facilitator 420 (e.g., facilitator 220 as described with respect to FIG. 2), a payment network 430 (e.g., payment network 230 as described with respect to FIG. 2), and a mapping service 450. The mapping service 450 can include a database 455. In some cases, the mapping service 450 can include the registration system 415.

In some cases, the mapping service 450 can be hosted by the facilitator 420. In some cases, the mapping service 450 can be hosted by the payment network 430.

The mapping service 450 is a service that enables users (e.g., cardholder 405) having a PAN (or other suitable financial account or payment device) to generate and/or register one or more public keys as delegates of a particular payment device (e.g., personal account number (PAN).

For example, the cardholder 405, via a user device 410 (e.g., a mobile device, a computing device, a client (e.g., client 205 described with respect to FIG. 2), etc.) use a registration system 415 to generate and/or register a delegate public key for a payment card at the mapping service 450. Key generation can be performed by the user device 410 to generate a private key and public key pairing. The cardholder 405 can register the corresponding public key with the mapping service 450 against a particular PAN of a payment device associated with the cardholder 405.

For example, assume that the cardholder 405 has a payment card with the PAN [1]. The cardholder 405, via the user device 410 can provide the PAN [1] to the mapping service 450 via the registration system 415. In some cases, the registration system 415 can perform security checks and/or authentications (e.g., requiring identification, one-time-passwords (OTP), etc.).

Through the registration system 415 the cardholder can register a public key with the mapping service 450 for each of their delegates. For example, as shown in FIG. 4, the database stores two delegates of PAN [1]: Public Key11 and Public Key12.

The database 455 can store combinations of public keys and PANs (e.g., PAN [1] and Public Key11). In some cases, each combination of public key and PAN includes at least one PAN having at least one public key as a delegate of the at least one PAN.

Advantageously, the delegate public keys can be distributed by the cardholder 405 for authorized use by delegated entities. For example, the cardholder 405 can set up a bot client (e.g., client 205 described with respect to FIG. 2) to make purchases on behalf of the cardholder 405. In some cases, the cardholder 405 may provide a delegate public key to another person (e.g., a child) for authorized use by that person.

In some cases, the delegate public keys associated with a particular PAN can have constraints. The constraints can be any rules for the use of the particular public key/PAN pairing. Examples of constraints can include, but are not limited to, spend constraint (e.g., max/min spend), merchant category code (MCC) constraint (e.g., valid MCC codes for purchase), duration constraints (e.g., start/end time and/or date), location constraints (e.g., location of transaction) and frequency constraints (e.g., 1-time use, daily, monthly, etc.). In some cases, the cardholder 405 can specify particular constraints to be associated with a particular delegate public key during registration.

The facilitator 420 and/or payment network 430 can utilize the database 455 during the process 290 as described with respect to FIG. 2. Referring now to FIGS. 2 and 4, the facilitator 420 and/or payment network 430 can utilize the database 455 to determine whether a public key corresponding to the cryptographic signature is a delegate of a particular PAN.

For example, consider step (260) of the process 290 where the facilitator 220/420 generates an authorization request message. At this stage, if the facilitator 220/420 hosts the mapping service 450, the facilitator 220/420 can determine whether a public key corresponding to the cryptographic signature received in the transaction request (at step (258)) is a delegate of the PAN received in the transaction request. For example, the facilitator 220/420 can perform a look up at the database 455 for the public key and/or the PAN. The facilitator 220/420 can include the result of the determination whether a public key is a delegate of the PAN in the authorization request message (e.g., sent at step (262)). In some cases, if the delegate public key includes one or more constraints, the facilitator 220/420 can include the one or more constraints in the authorization request message.

As an additional example, consider step (264) of the process 290 where the payment network 230/430 receives the authorization request message. At this stage, if the payment network 230/430 is hosting the mapping service 450, the payment network 230/430 can determine whether a public key corresponding to the cryptographic signature received in the authorization request message (at step (262)) is a delegate of the PAN received in the authorization request message. For example, the payment network 230/430 can perform a look up at the database 455 for the public key and/or the PAN. The payment network 230/430 can determine whether a public key corresponding to the cryptographic signature is a delegate of the PAN. The payment network 230/430 can perform the authorization (e.g., at step (264) based in part on the result of the determination of whether a public key corresponding to the cryptographic signature is a delegate of the PAN. For example, if it is determined that a public key corresponding to the cryptographic signature is a delegate of the PAN, the payment network 230/430 can send a positive authorization response at step (266). As another example, if it is determined that a public key corresponding to the cryptographic signature is not a delegate of the PAN, the payment network 230/430 can send a negative authorization response at step (266).

In some cases, the authorization response can be based on one or more constraints associated with a public key corresponding to the cryptographic signature. For example, in a scenario where a public key corresponding to the cryptographic signature is a delegate of the PAN, but has an amount constraint of $100, if the transaction is for $200, the payment network 230/430 can send a negative authorization response at step (266) as a result of the conditions of the constraints related to the delegate not being met.

Advantageously, various constraints help the payment network 230/430 efficiently make an authorization decision without additional computational burden on the issuer 240.

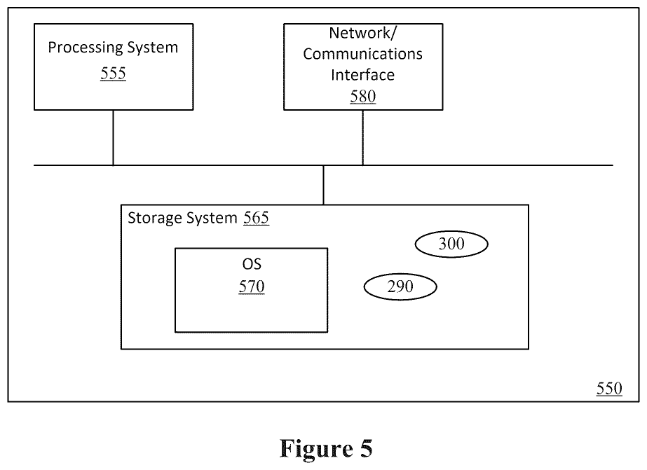

FIG. 5 illustrates components of a computing system that may be used in certain embodiments of the client 205, the server 210, the facilitator 220/420 and payment network 230/430 described herein. Referring to FIG. 5, system 550 can include one or more blade server devices, personal computers, routers, hubs, switches, bridges, firewall devices, intrusion detection devices, mainframe computers, network-attached storage devices, and other types of computing devices. The system hardware can be configured according to any suitable computer architecture.

The system 550 can include a processing system 555, which may include one or more processors and/or other circuitry that retrieves and executes software from the storage system 565.

The processing system 555 may be implemented within a single processing device but may also be distributed across multiple processing devices or sub-systems that cooperate in executing program instructions.

The storage system 565 can store an operating system 570 and software for executing various implementations of method 300, including operation 290, described herein. Storage system 565 may also or alternatively store database 455.

Storage system 565 may include volatile and nonvolatile memories, removable and non-removable media implemented in any method or technology for storage of information, such as computer readable instructions, data structures, program modules, or other data. Examples of storage media of storage system 565 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage system 565 may be implemented as a single storage device but may also be implemented across multiple storage devices or sub-systems co-located or distributed relative to each other. Storage system 565 may include additional elements, such as a controller, capable of communicating with processing system 555. The storage system 565 may also include storage devices and/or sub-systems on which data is stored. System 550 may access one or more storage resources in order to access information to carry out any of the processes (e.g., method 300) indicated by software.

Software at the storage system 565 may be implemented in program instructions and among other functions may, when executed by system 550 in general or processing system 555 in particular, direct system 550 or the one or more processors of processing system 555 to operate as described herein (e.g., method 300).

Network interface 580 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS 570, which informs applications of communications events when necessary.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method, comprising:
during a session between a client and a server over an Internet protocol in which purchasable resources managed by the server is being or is to be accessed or consumed by the client, receiving, at a facilitator, a transaction request message for a transaction comprising a transaction identifier, a transaction amount, a personal account number (PAN), and a cryptographic signature transmitted to the server from the client as part of the session;
generating, at the facilitator, an authorization request message comprising at least the PAN and the cryptographic signature;
sending, by the facilitator, the authorization request message to a payment network;
receiving, at the facilitator from the payment network, an authorization response indicating approval of the transaction based on a public key corresponding to the cryptographic signature being a delegate of the PAN; and
sending, from the facilitator to the server, payment authorization confirmation during the session.

2. The method of claim 1, further comprising:
before generating the authorization request message, determining, by the facilitator, that the public key corresponding to the cryptographic signature is the delegate of the PAN;
wherein generating the authorization request message further comprises appending, by the facilitator, an indication that the public key corresponding to the cryptographic signature is a delegate of the PAN to the authorization request message.

3. The method of claim 2, wherein determining that the public key corresponding to the cryptographic signature is a delegate comprises:
performing, by the facilitator, a look up at a database for the public key or the PAN, wherein the database stores combinations of public keys and PANs; and
identifying that the public key is a delegate of the PAN.

4. The method of claim 1, wherein the payment network determines that the public key corresponding to the cryptographic signature is a delegate of the PAN by:
performing, by the payment network, a look up at a database for the public key or the PAN, wherein the database stores combinations of public keys and PANs, wherein each combination of public keys and PANs includes at least one PAN having at least one public key as a delegate of the at least one PAN;
identifying that the public key is a delegate of the PAN; and
generating the authorization response indicating approval of the transaction based on the public key being a delegate of the PAN.

5. The method of claim 1, wherein the transaction request message is an HTTP message.

6. The method of claim 1, wherein information including the cryptographic signature transmitted to the server from the client as part of the session is communicated between the client and the server in an X402 standard.

7. The method of claim 1, wherein the authorization request message is an ISO 8583 message.

8. The method of claim 1, further comprising:
during a second session between a second client and a second server over the Internet protocol in which second purchasable resource managed by the second server is being or is to be accessed by the second client, the second session comprising a second user requesting consumption of purchasable resource managed by the second server via the second client, receiving, at the facilitator, a second transaction request message comprising a second transaction identifier, a second transaction amount, a second personal account number (PAN), and a second cryptographic signature;
generating, at the facilitator, a second authorization request message comprising at least the second PAN and the second cryptographic signature;
sending, by the facilitator, the second authorization request message to the payment network;
receiving, at the facilitator from the payment network, a second authorization response indicating denial of the transaction based on a second public key corresponding to the second cryptographic signature not being a delegate of the PAN; and
sending, from the facilitator to the second server, payment authorization denial during the session.

9. The method of claim 1, wherein the client is an artificial intelligence (AI) agent or a bot.

10. A system, comprising:
a processing system;
a communications interface;
a storage system; and
instructions stored in the storage system that, when executed by the processing system, direct the system to at least:
during a session between a client and a server over an Internet protocol in which content hosted by the server is being or is to be accessed by the client, receive a transaction request message comprising a transaction identifier, a transaction amount, a personal account number (PAN), and a cryptographic signature transmitted to the server from the client as part of the session;
generate an authorization request message comprising at least the PAN and the cryptographic signature;
send the authorization request message to a payment network;
receive, from the payment network, an authorization response indicating approval of the transaction based on a public key corresponding to the cryptographic signature being a delegate of the PAN; and
send, to the server, payment authorization confirmation during the session.

11. The system of claim 10, wherein the instructions further direct the system to:
before generating the authorization request message, determine that the public key corresponding to the cryptographic signature is the delegate of the PAN;
wherein the instructions to generate the authorization request message further direct the system to append an indication that the public key corresponding to the cryptographic signature is a delegate of the PAN to the authorization request message.

12. The system of claim 11, further comprising:
a database storing combinations of public keys and PANs, wherein each combination of public keys and PANs includes at least one PAN having at least one public key as a delegate of the at least one PAN;
wherein the instructions further direct the system to:
perform a look up at the database for the public key or the PAN; and
identify that the public key corresponding to the cryptographic signature is a delegate of the PAN.

13. The system of claim 10, wherein the payment network determines that the public key corresponding to the cryptographic signature is a delegate of the PAN by:
performing, by the payment network, a look up at a database for the public key or the PAN, wherein the database stores combinations of public keys and PANs;
identifying that the public key is a delegate of the PAN; and
generating the authorization response indicating approval of the transaction based on the public key being a delegate of the PAN.

14. The system of claim 10, wherein the transaction request message is an HTTP message.

15. The system of claim 10, wherein the authorization request message is an ISO 8583 message.

16. A computer readable storage medium having instructions stored thereon that when executed by a processing system, direct the processing system to at least:
during a session between a client and a server over an Internet protocol in which content hosted by the server is being or is to be accessed by the client, receive, at a facilitator, a transaction request message comprising a transaction identifier, a transaction amount, a personal account number (PAN), and a cryptographic signature transmitted to the server from the client as part of the session;
generate an authorization request message comprising at least the PAN and the cryptographic signature;
send the authorization request message to a payment network;
receive, from the payment network, an authorization response indicating approval of the transaction based on a public key corresponding to the cryptographic signature being a delegate of the PAN; and
send, to the server, payment authorization confirmation during the session.

17. The computer readable storage medium of claim 16, wherein the instructions further direct the processing system to:
before generating the authorization request message, determine that the public key corresponding to the cryptographic signature is the delegate of the PAN;
wherein the instructions to generate the authorization request message further direct the processing system to append an indication that the public key corresponding to the cryptographic signature is a delegate of the PAN to the authorization request message.

18. The computer readable storage medium of claim 17, wherein the instructions further direct the processing system to:
perform a look up at a database for the public key corresponding to the cryptographic signature or the PAN, wherein the database stores combinations of public keys and PANs, wherein each combination of public keys and PANs includes at least one PAN having at least one public key as a delegate of the at least one PAN; and
identify that the public key is a delegate of the PAN.

19. The computer readable storage medium of claim 16, wherein the transaction request message is an HTTP message.

20. The computer readable storage medium of claim 16, wherein the authorization request message is an ISO 8583 message.
